(19) United States
(12) Patent Application Publication
(10) Pub. No.: US 2017/0103577 A1
(43) Pub. Date: Apr. 13, 2017

(54) METHOD AND APPARATUS FOR OPTIMIZING VIDEO STREAMING FOR VIRTUAL REALITY

(71) Applicant: Cinova Media, Mountain View, CA (US)

(72) Inventors: Anurag Mendhekar, Mountain View, CA (US); Ravi Gauba, Mountain View, CA (US); Subhrendu Sarkar, Mountain View, CA (US); Santosh Shirahatti, Mountain View, CA (US)

(21) Appl. No.: 15/291,953

(22) Filed: Oct. 12, 2016

Related U.S. Application Data
(60) Provisional application No. 62/240,442, filed on Oct. 12, 2015.
(60) Provisional application No. 62/291,447, filed on Feb. 4, 2016.

(51) Int. Cl. G06T 19/00; H04L 29/06

(52) U.S. Cl. CPC G06T 19/006; H04L 65/60; H04L 65/607

(57) ABSTRACT

A system and method for reducing the bandwidth requirements for virtual reality using selective optimization are provided. The system selectively optimizes pre-encoded Virtual Reality video based on viewport information received from the headset.

### PRIORITY CLAIMS/RELATED APPLICATIONS

This application claims the benefit under 35 USC 119(e) and priority under 35 USC 120 to U.S. Provisional Patent Application Ser. No. 62/240,442 filed on Oct. 12, 2015 and entitled “Method And Apparatus For Optimizing Video Streaming For Virtual Reality” and U.S. Provisional Patent Application Ser. No. 62/291,447 filed Feb. 4, 2016 and entitled “Method And Apparatus For Optimizing Video Streaming For Virtual Reality”, the entirety of both of which are incorporated herein by reference.

### FIELD

The disclosure relates generally to virtual reality systems and methods.

### BACKGROUND

Virtual reality (VR) video involves the capture, transmission and viewing of full 360-degree video, which are typically stereoscopic. When VR Video is streamed over networks, the 360-degree video is projected onto a rectangular surface, and encoded and transmitted as a traditional (flat 2-dimensional) video. For stereoscopic video, two views are typically combined into a single view and encoded and transmitted as a single video stream.

An example of a VR video projected onto a rectangular surface is shown in FIG. 1. A viewer typically views this video using a headset that plays back only a section of the whole video, based on the direction in which the headset is pointed. A virtual reality headset is any device that can directly deliver an immersive visual experience to the eyes based on positional sensors. The virtual reality headset may include special purpose Virtual Reality devices, but may also include a mobile phone or tablet with a viewing accessory. For example, the virtual reality device may provide a viewport that has a left eye view portion 20 and a right eye view portion 22 as shown by the overlapping ovals shown in FIG. 2. Depending upon the configuration of the viewing device, the field of view of the headset determines the specific portion of the frame. As an example, a device with a 90-degree horizontal and vertical field of view, will only display about 1/4^{th} of the frame in the horizontal direction and 1/2 of the frame in the vertical direction.

When the viewer moves his or her head in another direction, the player plays a different section of the video in each eye that corresponds to the new direction in which the headset is pointed. This is what provides an immersive experience to the viewer. As a result, at any given time, only a portion of any given video frame is viewed.

When VR video is streamed over a network, the video bandwidth required to transmit VR video using traditional methods can be as high as 20-50 times the bandwidth required by non-VR (also referred to as “flat” or “normal” video) videos, depending upon chosen resolutions. This is because unlike traditional single view cameras that only capture light from the front, 360-degree cameras capture light from all directions and usually in stereoscopic mode. This causes an explosion in the number of pixels captured and transmitted. At the headset, however, only a fraction of these pixels are displayed at any given instant, because the viewer is only viewing pixels coming from a certain direction.

### BRIEF DESCRIPTION OF THE DRAWINGS

FIG. 1 illustrates a typical virtual reality (VR) video;

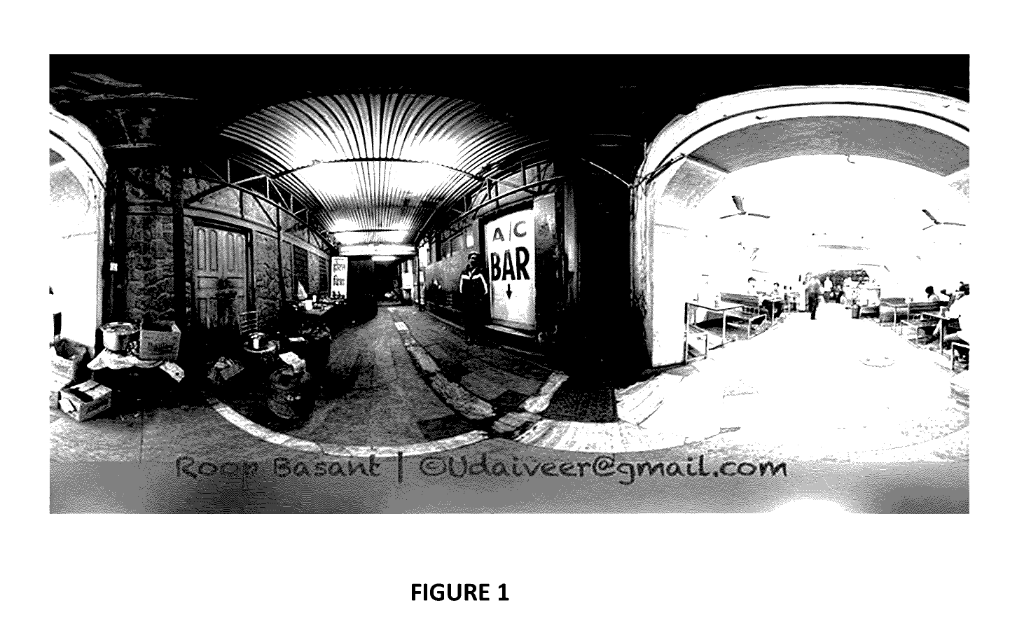

FIG. 2 illustrates an example of a region of the frame in view of the headset; and

FIG. 3 illustrates an example of an embodiment of a virtual reality optimized system and method.

### DETAILED DESCRIPTION OF ONE OR MORE EMBODIMENTS

The disclosure is directed to a virtual reality stream/frames system using a particular video compression scheme and a particular virtual reality headset and it is in this context that the disclosure is directed. However, the system and method has greater utility since it can be used with various different video stream having various different compression and decompressions schemes known or yet to be developed and may be used with various different virtual reality devices including the virtual reality headset described in the examples below.

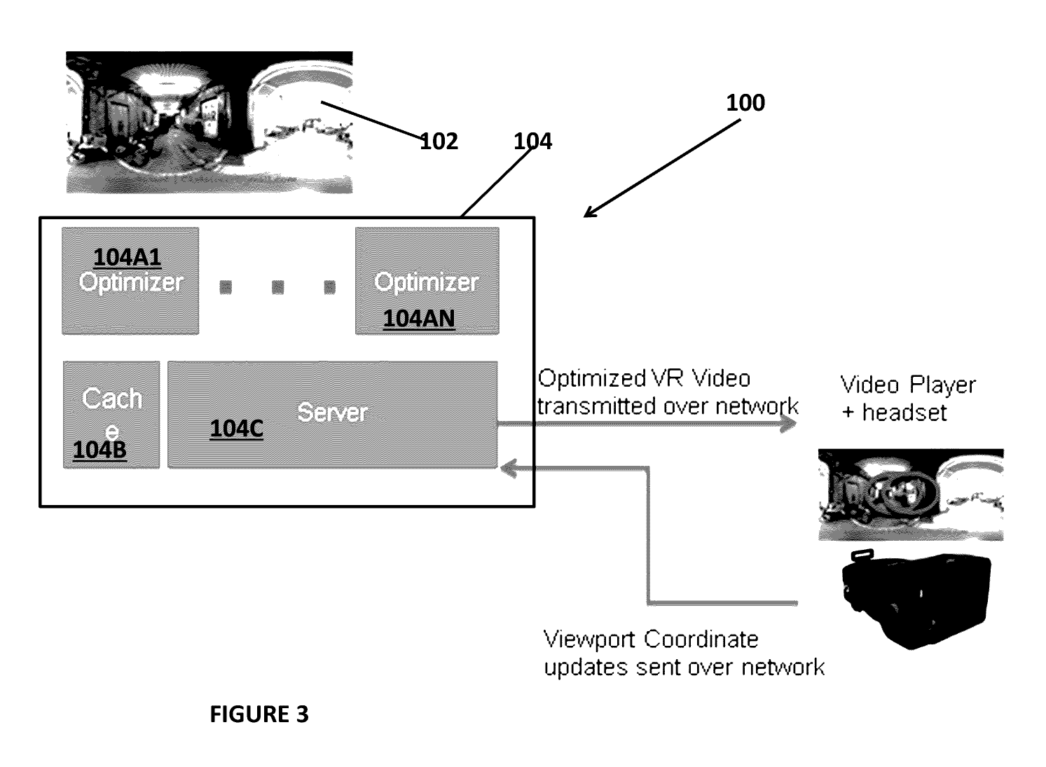

FIG. 3 illustrates an example of an embodiment of a virtual reality optimized system 100 and method. As shown in FIG. 3, one or more frames of a virtual reality view/frame 102 may be fed into a VR processor system 104 that can optimize the bandwidth requirements of the virtual reality view/frame 102. The system 100 may gather virtual reality views/frames 102 for a plurality of different sources and the. For example, in response to a request from a video player that is within a virtual reality headset, the system may identify the particular virtual reality views/frames 102 from the video player request and receive those particular virtual reality views/frames 102 from the video player request to optimize those frames.

The VR processor system 104 may be implemented in software or hardware to implement the functions below. When the VR processor system 104 is implemented in software, the elements shown in FIG. 3 may be implemented as a plurality of lines of computer code that may be executed by a computing resource (cloud resource including a processor, memory and/or connectivity, a server computer, a blade computer, an application server and the like) and a processor.

FIG. 3 shows the system 100 implemented in hardware in which the VR processor system 104 has one or more components including one or more optimizers 104A1, . . . , 104AN, a cache 104B and a server 104C as shown. The system may also have video player as described below in more detail. In the software implementation, each of the components is a plurality of lines of computer code executed by a processor of a computer system. In the hardware implementation, each of the components may be a hardware device such as a microcontroller, a programmable logic device, a field programmable gate array and the like.

The system 100 reduces the bandwidth required in transmitting VR video by using variable levels of compression for a frame, based on which section of the frame is being used by the headset. In the system, it is assumed that the VR video is already projected onto rectangular frames and pre-encoded using a conventional video encoding technique such as h.264 (MPEG4/AVC) or its predecessors (h.263) or successors (such as h.265, HEVC), or equivalents thereof. The system 100 that takes one or many such pre-encoded VR video files and serves them to one or more headset in a way that drastically reduces the bandwidth required to serve these videos without compromising the viewing experience. The pre-encoded video file/stream may be processed in a compressed domain or the pre-encoded video file/stream may be decoded, processed and re-encoded as part of the method.

As shown in FIG. 3, the system 100 has the server 104C that will receive requests over a network for VR video streams from one or more headsets running a specialized video player that can capture and transmit the coordinates of the area of the frame that is being viewed (called viewport in the rest of this document). The server 104C also periodically receives updates from the headset about the changes in the viewport. The server is also assisted by one or more Optimizers 104A1-104AN, which optimize video streams based on the viewport information received from the headset. The cache 104B can save previously optimized video frames and can serve them directly without further optimization if they are available in order to assist the server.

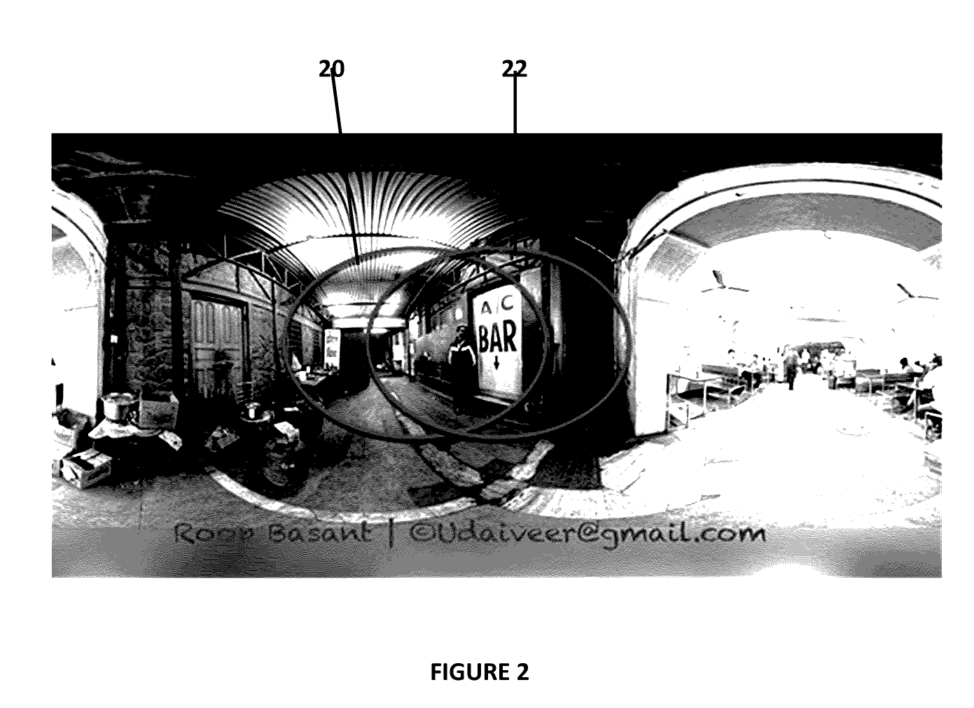

It should be noted that the viewport identified at any time by the video player/virtual reality device is less than the entire virtual reality frame, such as for example as shown in FIG. 2.

Video Player on Each Headset

The video player may be, in some embodiments, a software component that can play video on the headset. The primary role of the video player is to play the frames of the VR video and change the view for the user anytime the headset is moved. For this system, the player has an additional function as described below.

The video player on the headset uses sensor information provided by the headset to continuously record viewport coordinates. These coordinates can take many forms, but one example of such coordinates are the values of x and y coordinates of the center of the viewport relative to the top-left corner of the rectangular frame of the pre-encoded VR video. The player starts at some default initial coordinates and transmits these viewport coordinates to the server anytime there is a change to them. The player may also employ various techniques such as averaging to minimize the frequency at which these updates are sent.

Video Server

The server 104C is responsible for transmitting optimized video to the video player and for collecting and responding to the viewport information sent by the video player.

There are two main scenarios that the Video Server handles:

Scenario 1: Initial request for video from the player. When the first request for the VR video is received by the server from the player, the server locates the stream or file (henceforth called stream) corresponding to the pre-encoded VR video (such as by extracting a URL, etc. from the request) in the request and starts an optimizer for this stream with the default initial viewport for the video.

Scenario 2: Viewport update from the player. When the video player sends a viewport update to the server it notifies the optimizer about the change in the viewport so that the optimizer can respond appropriately.

Optimizer(s)

Each optimizer 104A1, . . . , 104AN is responsible for reducing the amount of information associated with any given frame of the input VR video based on the viewport information available to it by combining video compression techniques with a multitude of optimization techniques.

One technique for optimization is as follows. First, the optimizer identifies a region around the viewport coordinates using one of a number of different techniques (for example, a rectangle of a fixed size). Then, using frequency domain transforms, the optimizer can drastically increase the compression levels of the regions outside this rectangle, so that they will consume far fewer bits. The reduction of bits may be achieved using techniques like frequency domain transforms and requantization of macroblocks. For example, using DCT based compression, this reduction of bits can be achieved by using higher quantization parameters, or by using non-linear functions that reduce the number of DCT coefficients in a macro block.

Another technique for optimization is to increase compression levels of regions of the frame based on the distance of the region from viewport coordinates. A function may be defined that maps the distance of a region from the viewport coordinates to specific parameter values that define how the frequency domain transforms or requantization of macroblocks may be applied. An example of this technique is to use higher quantization parameters for macroblocks that are farther away from the viewport coordinates. In one example, the macroblocks that represent pixels directly behind the viewer (behind the viewport) will get the highest quantization parameters.

A third technique for optimization is to split the entire frame into multiple sub frames. The details of this technique are described below as the “split-frame optimization.”

When the optimizer receives a change notification for the viewport coordinates, it begins optimizing all the future frames using the new coordinates, until further change notifications are received, or until the video is finished playing.

Using these selective region based optimizations of the video encoding, the overall bandwidth required by the video is significantly reduced. The method in this invention has been implemented using a compressed-domain optimizer that does not require a complete decode and re-encode of the video in order to reduce the bandwidth requirements. An optimizer that operates in the compressed domain can reduce bandwidth required by as much as 60%. When combined with other techniques, it can further provide bandwidth reduction by as much as 80-90%.

Cache

The cache 104B allows optimized frames to be saved and retrieved for individual viewport coordinates. The use of the cache is optional. It may be used to improve the throughput of the system by avoiding re-computing optimized frames if they have already been optimized before. In these instances, the server can simply retrieve the frames from the cache and serve them.

The cache can be predictively prepopulated using statistical, machine-learning or artificial intelligence methods by observing the viewing pattern across a multitude of users. An example of such a method is to create a model for linear regression that can make a prediction about where most headsets are likely to be at a given point in the playback of the VR video. Using this predictive model, an optimizer can pre-compute the optimized streams and save them in the cache. In such a scenario, each optimized stream predicts the most likely position of the viewport for each frame by using data from views of the video on real headsets from real users. This data will include information like actual headset position, and velocity of movement of the headset as well as acceleration. This technique can be used to drastically reduce the number of optimizers necessary. This technique can be especially useful when broadcasting timed events which can draw a very large number of viewers in a very short time interval.

One other extension of the cache would be to distribute it over a large geographic area. In this manner, streams (include pre-optimized ones) can be delivered to headsets from the closest possible geographic location.

Split Frame Optimization

A full stereoscopic VR frame consists of a very high resolution frame. For high quality, such a frame is typically a resolution 3840×3840 pixels. In one configuration, the top half of the frame is intended for the left eye and the bottom half of the frame is intended for the right eye. Other configurations are also possible. For non-stereoscopic VR, a single frame is used for both eyes. An example configuration would be a frame of 3840×1920 (which represents only one half of a stereoscopic frame).

In the non-stereoscopic VR example and split frame optimization, this large frame is broken up into two sub-frames. The first sub-frame represents the entire frame, but scaled down to a significantly lower resolution. For example, 3840×1920 VR frame will be sent at a 1280×640 resolution. The second sub-frame contains only the viewport, but without any scaling applied to it. Depending upon the resolution of the headset, this second stream will also be about the same resolution.

For a stereoscopic VR frame, this splitting is repeated for each eye, allowing a full resolution stereoscopic VR stream to be sent as 4 much smaller streams. This can enable as much an order of magnitude reduction in the bandwidth consumed, while still maintaining a full-resolution user experience.

In this scheme of optimization, the multiple sub-frames are delivered from the server to the player at the headset while maintaining the time synchronicity of the stream. There is additional metadata transmitted from the server to the player with each packet to synchronize the sub-frames. This metadata includes frame numbers, timestamps, high dynamic range data (such as tone maps), motion-vector maps and error resiliency data (for example, as may required for forward error correction) as well as the viewport location (which may be encoded as rotations of the headset.) The player processes the metadata to synchronize the frames and create a full 360 degree image/frame.

During the compositing process, quality metrics may be used to further optimize the quality of stream by performing additional filtering operations on the composite stream, or the individual subframes.

The sub-frames can further be optimized in other ways:
1. Encoding the first frame with all its pixels, but encoding the remaining sub-frames as derived from the first one as a function of the first frame. For example, the remaining sub frames could be encoded as difference of pixel values between the sub-frame and first frame. Other similar functions may also be used, including more sophisticated functions that combine differencing with filters that further reduce the number of bits in the final encoding.
2. Using bit-shifts of pixel values to eliminate bit planes that are noisy (such as described in U.S. Pat. No. 8,811,736 (Efficient content compression and decompression system and method) which is incorporated herein by reference.
3. Frames that represent spherical surfaces can use more efficient geometrical projections (such as mapping the spherical surface to a flat ellipse rather than the more conventional equirectangular projection) to reduce the number of pixels that will be encoded on that frame.
4. Adaptively encoding the sub-frames at variable bit-rates depending on combination of factors mentioned below.
5. Skip delivery of certain sub-frames to meet the average frame delivery times, yet maintain the quality and frame-rate in the headset with creation frames using the metadata.

All the above methods may be applied in an adaptive manner depending on the following factors:
1. Available network bandwidth and speed.
2. Type of network (Wireless Wi-fi, Ethernet, LTE)
3. Type of headset (Tethered HMD, Mobile HMD)
4. Display Resolution of HMD
5. Graphics Processing capabilities of the HMD
6. Network Congestion
7. Server Load

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A virtual reality system, comprising:
a virtual reality processor;
a video player installed in a virtual reality device, the video player sending viewport information about a viewport for a pre-encoded virtual reality data frame to be viewed by the virtual reality device to the virtual reality processor, the viewport identifying a portion of the pre-encoded virtual reality data frame to be displayed on virtual reality device based on an orientation of the virtual reality device and the portion of the pre-encoded virtual reality data frame identified by the viewport information being less than the entire pre-encoded virtual reality data frame; and
the virtual reality processor having an optimizer that optimizes the pre-encoded virtual reality data frame based on the viewport information to generate an optimized virtual reality data frame that reduces a bandwidth required to communicate the optimized virtual reality data frame.

2. The system of claim 1, wherein the optimizer increases a compression level for a region of the pre-encoded virtual reality frame that is not within the portion of the pre-encoded virtual reality data frame identified by the viewport.

3. The system of claim 2, wherein the optimizer uses frequency domain transforms and re-quantization of macroblocks to increase the compression level.

4. The system of claim 1, wherein the optimizer increases a compression level for a region in the pre-encoded virtual reality frame a predetermined distance from the portion of the pre-encoded virtual reality data frame identified by the viewport.

5. The system of claim 1, wherein the optimizer performs sub-frame optimization in which the pre-encoded virtual reality frame is divided into one or more sub-frames and each sub-frame is optimized.

6. The system of claim 5, wherein the pre-encoded virtual reality frame is a non-stereoscopic pre-encoded virtual reality frame and the optimizer generates a first sub-frame that contains the non-stereoscopic pre-encoded virtual reality frame at a lower resolution and generates a second sub-frame that contains the portion of the pre-encoded virtual reality data frame identified by the viewport of the non-stereoscopic pre-encoded virtual reality frame at full resolution.

7. The system of claim 5, wherein the pre-encoded virtual reality frame is a stereoscopic pre-encoded virtual reality frame and the optimizer generates a first sub-frame that contains the stereoscopic pre-encoded virtual reality frame at a lower resolution for a left eye, generates a second sub-frame that contains the stereoscopic pre-encoded virtual reality frame at a lower resolution for a right eye, generates a third sub-frame that contains the portion of the pre-encoded virtual reality data frame identified by the viewport of the stereoscopic pre-encoded virtual reality frame at full resolution for the left eye and generates a fourth sub-frame that contains the portion of the pre-encoded virtual reality data frame identified by the viewport of the stereoscopic pre-encoded virtual reality frame at full resolution for the right eye.

8. The system of claim 5, wherein the optimizer optimizes a subframe by encoding a first subframe and encoding a second subframe based on the first subframe.

9. The system of claim 5, wherein the optimizer optimizes a subframe using bit shifts that eliminate a bit plane in the subframe.

10. The system of claim 5, wherein the optimizer optimizes a subframe using a geometric projection for a subframe that has a spherical surface displayed in the subframe.

11. The system of claim 5, wherein the optimizer optimizes a subframe using adaptive encoding.

12. The system of claim 5, wherein the optimizer optimizes a subframe by skipping the subframe.

13. The system of claim 1, wherein the viewport information further comprises an identification of the pre-encoded virtual reality data.

14. The system of claim 1, wherein the virtual reality processor receives updated viewport information from the video player indicating that the viewport has changed due to a movement of the virtual reality device and wherein the optimizer generates an optimized virtual reality data frame that reduces a bandwidth required to communicate the optimized virtual reality data frame for the updated viewport.

15. The system of claim 1, wherein the virtual reality processor further comprises a cache that stores a plurality of optimized virtual reality data frames.

16. The system of claim 15, wherein the cache predictively generates the plurality of optimized virtual reality data frames stored in the cache.

17. The system of claim 1, wherein the virtual reality device is a virtual reality headset.

18. The system of claim 17, wherein the virtual reality headset has a sensor that determines the viewport information.

19. The system of claim 1, wherein the virtual reality processor sends the optimized virtual reality data frame to the video player.

20. A virtual reality processor, comprising:
a server that is capable of communicating with a video player in a virtual reality device, the server receiving viewport information about a viewport for a pre-encoded virtual reality data frame to be viewed by the virtual reality device, the viewport identifying a portion of the pre-encoded virtual reality data frame to be displayed on virtual reality device based on an orientation of the virtual reality device and the portion of the pre-encoded virtual reality data frame identified by the viewport information being less than the entire pre-encoded virtual reality data frame; and
an optimizer that optimizes the pre-encoded virtual reality data frame based on the viewport information to generate an optimized virtual reality data frame that reduces a bandwidth required to communicate the optimized virtual reality data frame.

21. The processor of claim 20, wherein the optimizer increases a compression level for a region of the pre-encoded virtual reality frame that is not within the portion of the pre-encoded virtual reality data frame identified by the viewport.

22. The processor of claim 21, wherein the optimizer uses frequency domain transforms and re-quantization of macroblocks to increase the compression level.

23. The processor of claim 20, wherein the optimizer increases a compression level for a region a predetermined distance from the portion of the pre-encoded virtual reality data frame identified by the viewport.

24. The processor of claim 20, wherein the optimizer performs sub-frame optimization in which the pre-encoded virtual reality frame is divided into one or more sub-frames and each sub-frame is optimized.

25. The processor of claim 24, wherein the pre-encoded virtual reality frame is a non-stereoscopic pre-encoded virtual reality frame and the optimizer generates a first sub-frame that contains the non-stereoscopic pre-encoded virtual reality frame at a lower resolution and generates a second sub-frame that contains the portion of the pre-encoded virtual reality data frame identified by the viewport of the non-stereoscopic pre-encoded virtual reality frame at full resolution.

26. The processor of claim 24, wherein the pre-encoded virtual reality frame is a stereoscopic pre-encoded virtual reality frame and the optimizer generates a first sub-frame that contains the stereoscopic pre-encoded virtual reality frame at a lower resolution for a left eye, generates a second sub-frame that contains the stereoscopic pre-encoded virtual reality frame at a lower resolution for a right eye, generates a third sub-frame that contains the portion of the pre-encoded virtual reality data frame identified by the viewport of the stereoscopic pre-encoded virtual reality frame at full resolution for the left eye and generates a fourth sub-frame that contains the portion of the pre-encoded virtual reality data frame identified by the viewport of the stereoscopic pre-encoded virtual reality frame at full resolution for the right eye.

27. The processor of claim 24, wherein the optimizer optimizes a subframe by encoding a first subframe and encoding a second subframe based on the first subframe.

28. The processor of claim 24, wherein the optimizer optimizes a subframe using bit shifts that eliminate a bit plane in the subframe.

29. The processor of claim 24, wherein the optimizer optimizes a subframe using a geometric projection for a subframe that has a spherical surface displayed in the subframe.

30. The processor of claim 24, wherein the optimizer optimizes a subframe using adaptive encoding.

31. The processor of claim 24, wherein the optimizer optimizes a subframe by skipping the subframe.

32. The processor of claim 20, wherein the viewport information further comprises an identification of the pre-encoded virtual reality data.

33. The processor of claim 20, wherein the server receives an updated viewport from the video player indicating that the viewport has changed due to a movement of the virtual reality device and wherein the optimizer generates an optimized virtual reality data frame that reduces a bandwidth required to communicate the optimized virtual reality data frame for the updated viewport.

34. The processor of claim 20 further comprising a cache that stores a plurality of optimized virtual reality data frames.

35. The processor of claim 34, wherein the cache predictively generates the plurality of optimized virtual reality data frames stored in the cache.

36. A method for virtual reality data processing, comprising:
receiving viewport information about a viewport for a pre-encoded virtual reality data frame to be viewed by a virtual reality device, the viewport identifying a portion of the pre-encoded virtual reality data frame to be displayed on virtual reality device based on an orientation of the virtual reality device and the portion of the pre-encoded virtual reality data frame identified by the viewport information being less than the entire pre-encoded virtual reality data frame; and
optimizing the pre-encoded virtual reality data frame based on the viewport information to generate an optimized virtual reality data frame that reduces a bandwidth required to communicate the optimized virtual reality data frame.

37. The method of claim 36, wherein optimizing the pre-encoded virtual reality data frame further comprises increasing a compression level for a region of the pre-encoded virtual reality frame that is not within the portion of the pre-encoded virtual reality data frame identified by the viewport.

38. The method of claim 37, wherein optimizing the pre-encoded virtual reality data frame further comprises using frequency domain transforms and re-quantization of macroblocks to increase the compression level.

39. The method of claim 36, wherein optimizing the pre-encoded virtual reality data frame further comprises increasing a compression level for a region a predetermined distance from the portion of the pre-encoded virtual reality data frame identified by the viewport.

40. The method of claim 36, wherein optimizing the pre-encoded virtual reality data frame further comprises performing sub-frame optimization in which the pre-encoded virtual reality frame is divided into one or more sub-frames and each sub-frame is optimized.

41. The method of claim 40, wherein the pre-encoded virtual reality frame is a non-stereoscopic pre-encoded virtual reality frame and optimizing the pre-encoded virtual reality data frame further comprises generating a first sub-frame that contains the non-stereoscopic pre-encoded virtual reality frame at a lower resolution and generating a second sub-frame that contains the portion of the pre-encoded virtual reality data frame identified by the viewport of the non-stereoscopic pre-encoded virtual reality frame at full resolution.

42. The method of claim 40, wherein the pre-encoded virtual reality frame is a stereoscopic pre-encoded virtual reality frame and optimizing the pre-encoded virtual reality data frame further comprises generating a first sub-frame that contains the stereoscopic pre-encoded virtual reality frame at a lower resolution for a left eye, generating a second sub-frame that contains the stereoscopic pre-encoded virtual reality frame at a lower resolution for a right eye, generating a third sub-frame that contains the portion of the pre-encoded virtual reality data frame identified by the viewport of the stereoscopic pre-encoded virtual reality frame at full resolution for the left eye and generating a fourth sub-frame that contains the portion of the pre-encoded virtual reality data frame identified by the viewport of the stereoscopic pre-encoded virtual reality frame at full resolution for the right eye.

43. The method of claim 40, wherein optimizing the subframe further comprises encoding a first subframe and encoding a second subframe based on the first subframe.

44. The method of claim 40, wherein optimizing the subframe further comprises using bit shifts that eliminate a bit plane in the subframe.

45. The method of claim 40, wherein optimizing the subframe further comprises using a geometric projection for a subframe that has a spherical surface displayed in the subframe.

46. The method of claim 40, wherein optimizing the subframe further comprises using adaptive encoding.

47. The method of claim 40, wherein optimizing the subframe further comprises skipping the subframe.

48. The method of claim 36, wherein the viewport information further comprises an identification of the pre-encoded virtual reality data.

49. The method of claim 36 further comprising receiving an updated viewport from the video player indicating that the viewport has changed due to a movement of the virtual reality device and generating an optimized virtual reality data frame that reduces a bandwidth required to communicate the optimized virtual reality data frame for the updated viewport.

50. The method of claim 36 further comprising caching a plurality of optimized virtual reality data frames.

51. The method of claim 50, wherein caching the plurality of optimized virtual reality data frames further comprises predictively generating the plurality of optimized virtual reality data frames stored in the cache.
